(19) United States
(12) Patent Application Publication
(10) Pub. No.: US 2011/0003074 A1
(43) Pub. Date: Jan. 6, 2011

(54) METHOD FOR THE PRODUCTION OF IRON-DOPED CARBONS

(75) Inventors: Ralf Böhling, Lorsch (DE); Jörg Pastre, Bensheim (DE); Katrin Freitag, Ludwigshafen (DE)

Correspondence Address: CONNOLLY BOVE LODGE & HUTZ LLP, P.O. BOX 2207, WILMINGTON, DE, 19899, US

(73) Assignee: BASF SE, Ludwigshafen (DE)

(21) Appl. No.: 12/919,745

(22) PCT Filed: Feb. 26, 2009
(86) PCT No.: PCT/EP2009/052284

§ 371 Date: Aug. 26, 2010

(30) Foreign Application Priority Data
Feb. 27, 2008 (EP) 08151974.6

(51) Int. Cl. B05D 5/00

(52) U.S. Cl. 427/217

(57) ABSTRACT

A process for the preparation of a metal-doped support material. The metal-doped support material comprises at least one metal in elemental form on at least one support material which is based on carbon by gas-phase deposition of at least one compound comprising the at least one metal in the oxidation state 0 in combination with carbon monoxide on the at least one support material and thermal decomposition of the at least one compound comprising the at least one metal in the oxidation state 0 in order to obtain the at least one metal in elemental form. During and after the deposition and the decomposition, the support material is not brought into contact with reducing compounds during the preparation.

The present invention relates to a process for the preparation of a metal-doped support material comprising at least one metal in elemental form on at least one support material which is based on carbon by gas-phase deposition of at least one compound comprising the at least one metal in the oxidation state 0 on the at least one support material and thermal decomposition of the at least one compound comprising at least one metal in the oxidation state 0 in order to obtain the at least one metal in elemental form, wherein, during and after the deposition and the decomposition, the support material is not brought into contact with reducing compounds during the preparation, a metal-doped support material which can be prepared by this process and the use of this metal-doped support material in the treatment of wastewater and contaminated groundwater.

Iron-doped carbon can be used for soil and groundwater decontamination. So-called pump-and-treat methods in which the contaminated groundwater is pumped to the surface, is cleaned there and is fed back to the groundwater have been used for this purpose to date. Passive barriers in the aquifer, so-called reaction walls, constitute an alternative. The material usually used for this purpose is iron granules. Metallic iron serves as a reducing agent for numerous organic and inorganic substances. Thus, for example, chlorinated hydrocarbons are dechlorinated by metallic iron. High installation costs for the construction of the reaction walls are the main disadvantage compared with the pump-and-treat methods.

Instead of iron granules, very small iron particles can also be used. These may have the ability to be mobile in the aquifer and, owing to their large specific surface area, have a high reactivity. A further advantage of these iron particles is that there is no need to construct reaction walls entailing high capital costs.

The prior art discloses that the reactivity of the iron particles used can be increased by applying them to an active carbon support since active carbon effectively adsorbs the pollutants to be separated off.

The prior art discloses various processes for applying metallic iron to carbon particles.

J. van Wonterghem and S. Morup, J. Phys. Chem. 1988, 92, 1013-1016, disclose a process for the preparation of ultrafine iron particles on carbon by impregnation of the carbon with liquid iron pentacarbonyl and subsequent heating of the impregnated support material for decomposition of the iron pentacarbonyl into metallic iron.

DE 33 30 621 A1 discloses a process for the preparation of support catalysts comprising metals or metal compounds as the active component by deposition of metal carbonyls from the gas phase onto support materials having a large surface area, in which the metal carbonyls are cleaved oxidatively on the support materials. Because the deposition and decomposition of the metal carbonyls takes place on the support material according to DE 33 30 621 A1 in an oxidizing atmosphere, the corresponding metal oxides are obtained. A process for the preparation of metals in elemental form on a corresponding support material is not disclosed in said document.

GB 572,471 discloses a process for the purification of gases. Finely divided iron is used for this purpose, which iron removes from waste gases organic compounds comprising sulfur. The finely divided iron used is present on porcelain rings. These porcelain rings provided with iron are obtained by passing an iron carbonyl compound at a temperature of from 400 to 450° C. over the porcelain rings.

US 2004/0007524 A1 discloses a process for removing hydrocarbons and halogenated hydrocarbons from contaminated regions by use of a support material which comprises iron in the oxidation state 0. The support material comprising metallic iron is prepared, for example, by immersing the support material in a melt of a hydrated iron salt. After cooling of the support material with formation of iron oxide, the latter is converted into elemental iron by reductive treatment. Furthermore, according to US 2004/0007524 A1, such a support material can also be prepared by immersing the support material in an aqueous solution of an iron salt and, after drying, reducing the iron salt on the support material to elemental iron.

WO 03/006379 A1 discloses a process for the decontamination of wastewaters which are polluted with organic, halogenated compounds by use of granulated iron having a particle size of from 1 to 20 mm.

J. Schwar et al., J. Vac. Sci. Technol. A 9 (2), 1991, 238-249, discloses a process for the surface characterization of carbon-supported iron catalysts. These are prepared, inter alia, by gas-phase deposition of iron pentacarbonyl on carbon. After deposition of the iron pentacarbonyl, the catalyst precursor thus obtained is reduced with hydrogen. Furthermore, this document discloses that corresponding catalysts can be obtained by applying an aqueous solution of iron(III) nitrate to the carbon support and reducing the iron cations with hydrogen to elemental iron.

A disadvantage of the mechanical processes for the preparation of small iron particles is that they do not as a rule lead to the required small sizes of the iron particles and furthermore do not permit iron to penetrate into the pore structure of the active carbon. Furthermore, a process in which active carbon is impregnated with a solution of an iron salt and the elemental iron is then obtained by reduction gives an iron-laden active carbon but targeted control of the iron particle size and distribution is possible only to a limited extent. Furthermore, a salt which remains on the catalyst support and must be removed in a further process step inevitably forms as a result of the reduction of an iron salt. Furthermore, relatively large amounts of raw materials, for example hydrogen, are consumed in order to prepare the product, which leads to higher production costs.

It is therefore an object of the present invention to provide a process by means of which metals in elemental form, i.e. in the oxidation state 0, can be applied to a support material which is based on carbon. This process should lead to the desired metal-doped support materials as far as possible in one process step. In addition, metal-doped support materials which are distinguished by a particularly homogeneous distribution of the metal on the support material and in which the metal is also present in the pores of the support material should be obtainable by the process according to the invention. As large a surface area as possible of the metal-doped support material and a high load of metal are furthermore desirable.

These objects are achieved by a process for the preparation of a metal-doped support material comprising at least one metal in elemental form, the support material being based on carbon, by gas-phase deposition of at least one compound comprising the at least one metal in the oxidative state 0 on the at least one support material and thermal decomposition of the at least one compound comprising the at least one metal in the oxidative state 0 in order to obtain the at least one metal in elemental form, wherein, during and after the deposition and the decomposition, the support material is not brought into contact with reducing compounds during the preparation.

Furthermore, the objects are achieved by a metal-doped support material which can be prepared by the process according to the invention, and by the use of this metal-doped support material for the treatment of wastewater or contaminated groundwater.

In the process according to the invention, in general all support materials known to the person skilled in the art which are based on iron and are suitable for doping with at least one metal can be used.

In the present invention, “based on carbon” means that the support material used comprises essentially, i.e. >80% by weight, of carbon in its various modifications. In a preferred embodiment, the at least one support material is selected from the group consisting of carbons, for example carbon black, active carbon, carbon nanotubes and mixtures thereof. In a particularly preferred embodiment, active carbon is used as support material in the process according to the invention.

The support material used according to the invention generally has as high a BET surface area as possible. In a preferred embodiment, the BET surface area of the support material used is at least 300 m²/g, particularly preferably at least 700 m²/g, very particularly preferably at least 1000 m²/g, before the metal doping. In general, the BET surface area of the support material used does not exceed a value of 2500 m²/g before the metal doping.

The preferably used support material has a metal content of from 0.01 to 2% by weight, preferably from 0.02 to 1.2% by weight, particularly preferably from 0.03 to 1% by weight, before the actual metal doping according to the invention, the metal present preferably being iron.

The support material preferably used in the process according to the invention is active carbon, in a particularly preferred embodiment the active carbon being present in the form of pellets which have a particle size of from 0.1 to 12 mm, particularly preferably from 1 to 6 mm. Such active carbon is obtainable by processes known to the person skilled in the art whilst commercially available. Before the actual use in the treatment of wastewater, these preferably used pellets are brought to a particle size of from 0.1 to 10 μm by suitable methods, for example milling.

In the process according to the invention, at least one compound comprising the at least one metal in the oxidation state 0 is applied to the at least one support material by gas-phase deposition.

In general, all compounds which are known to the person skilled in the art and can be vaporized under technically realizable conditions, for example, at a temperature of from 30 to 400° C., preferably from 50 to 250° C., particularly preferably from 70 to 150° C., can be used in the process according to the invention. Furthermore, the compounds used should be vaporizable at a pressure of from 0.1 to 10 bar, preferably from 0.5 to 5 bar, particularly preferably at atmospheric pressure.

In a preferred embodiment, the metal present in the compound used which comprises at least one metal in the oxidation state 0 is a metal selected from the group consisting of the transition metals. In a particularly preferred embodiment, the at least one metal is selected from groups 3 to 12 (new IUPAC nomenclature), particularly preferably from groups 6 to 10. The metal which is present in the at least one compound is very particularly preferably selected from the group consisting of iron, nickel, cobalt, manganese, chromium, rhenium, molybdenum, tungsten and mixtures thereof. The metal is particularly preferably iron.

In the compound used according to the invention, the metal is present in the oxidation state 0. Preferably used complexes of the corresponding metal are those in which the ligands are not charged, so that in total an uncharged complex is present. Suitable ligands which are bound to the at least one metal are selected, for example, from the group consisting of CO, NO, PR₃ (R=alkyl with C₁-C₆ or aryl) and mixtures thereof. Carbonyl complexes of the corresponding metal which comprise at least one CO ligand are particularly preferably used. In a particularly preferred embodiment, the metal complexes used comprise exclusively CO ligands, i.e. so-called metal carbonyls are used.

Examples of corresponding carbonyls are selected from the group consisting of iron pentacarbonyl Fe(CO)₅, Cr(CO)₆, Mo(CO)₆, W(CO)₆, Mn₂(CO)₁₀, Re₂(CO)₁₀, Fe(CO)₅, Fe₂(CO)₉, Fe₃(CO)₁₂, CO₂(CO)₈, Ni(CO)₄ and mixtures thereof, particularly preferably iron pentacarbonyl Fe(CO)₅. These metal carbonyls, in particular iron pentacarbonyl, can be prepared by processes known to the person skilled in the art, for example described in Hollemann-Wiberg, Lehrbuch der Anorganischen Chemie, or are commercially available. In the process according to the invention, the compound comprising the at least one metal in the oxidation state 0 is preferably iron pentacarbonyl Fe(CO)₅. Iron pentacarbonyl is preferably prepared from iron granules by the process known to the person skilled in the art. For this purpose, iron granules are initially taken in an appropriate reactor, for example a tray reactor, and carbon monoxide CO flows through said granules. The resulting iron pentacarbonyl is separated from the CO exit stream by methods known to the person skilled in the art and, if appropriate, purified by methods known to the person skilled in the art.

The process according to the invention is generally carried out in such a way that the corresponding at least one compound comprising at least one metal in the oxidation state 0 is brought into contact in the gaseous state with the at least one support material.

In a preferred embodiment, the gas which comprises the at least one compound comprising a metal in the oxidation state 0 is passed over active carbon, preferably in a fixed bed. In the process, the at least one compound used comprising a metal in the oxidation state 0 is deposited on the support material, preferably on the active carbon. In a further embodiment of the process according to the invention, the process according to the invention is carried out in a fluidized bed.

In a particularly preferred embodiment, pressure and temperature and the heat input into the active carbon bed must be chosen so that the decomposition reaction of the iron pentacarbonyl is slow in comparison with the heat transport and mass transfer into the interior of the support material. If the decomposition rate of the iron pentacarbonyl is too rapid compared with the heat transport and/or mass transfer into the interior of the support material, the corresponding metal, for example, iron, will be at least partly deposited on the inner wall of the reactor but not, as desired, on the support material or in the pores of the support material.

In a preferred embodiment, the heat input into the active carbon bed can be effected by external heat exchangers which heat a part-stream of the exit gas in the circulation. The heated exit gas is recycled to the active carbon bed. Since the support materials used, in particular active carbon, act catalytically on the decomposition of the iron pentacarbonyl, the decomposition in the circulated gas heat exchanger is negligible compared with the decomposition on the support material.

In a preferred embodiment, the gaseous compound which comprises at least one metal in the oxidation state 0 is passed in combination with further gases, for example selected from the group consisting of carbon monoxide, carbon dioxide, nitrogen or noble gases and mixtures thereof, over or through the support material. The concentration in the at least one compound comprising the metal in the oxidation state 0, particularly preferably iron pentacarbonyl, in this gas is from 1 to 100% by weight, preferably from 10 to 95% by weight, based in each case on the total reaction gas.

In a preferred embodiment, the temperature in the interior of the reactor is so high that the at least one compound comprising a metal in the oxidation state 0 is present in vapor form and decomposition takes place on contact with the support material present. The vaporization temperature of iron pentacarbonyl is 105° C. and the decomposition temperature of iron pentacarbonyl is 150° C.

In the process according to the invention, the support material bed preferably has a temperature of from 120 to 220° C., particularly preferably from 130 to 200° C. The pressure in the support material bed is preferably from 0.1 to 10 bar, particularly preferably atmospheric pressure, i.e. 1 bar. The deposition and the decomposition are therefore preferably carried out at a temperature of from 120 to 220° C., particularly preferably from 130 to 200° C. The deposition and the decomposition are preferably carried out at a pressure of from 0.1 to 10 bar, particularly preferably at atmospheric pressure.

In a particularly preferred embodiment of the process according to the invention, in a first step, at least one compound comprising a metal in the oxidation state 0 is deposited at a temperature above the vaporization temperature and below the decomposition temperature on the at least one support material by passing said at least one compound in the vapor state over and/or through the support material. In a second step of this preferred embodiment of the process according to the invention, the feed of at least one compound in vapor form and comprising a metal in the oxidation state 0 is stopped, i.e. preferably no more compound in vapor form and comprising a metal in the oxidation state 0 is deposited on the support material, and the temperature is increased so that it is above the decomposition temperature, so that the at least one compound comprising a metal in the oxidation state 0 which has been deposited on the support material is decomposed into the corresponding metal, for example iron.

In a preferred embodiment of the process according to the invention, the decomposition of the compound comprising the metal in the oxidation state 0 is effected after the deposition on the support material. The decomposition of the deposited compound into elemental metal, preferably into iron, is effected in a preferred embodiment by the action of the active carbon surface in combination with a heat supply.

An advantage of the process according to the invention is that, during and after the deposition and the decomposition, the support material need not be brought into contact with reducing compounds, for example hydrogen, in the preparation in order to obtain the metal in elemental form. After decomposition of the compound comprising the metal in the oxidation state 0, the metal is present in elemental form and need not be further treated with a reducing agent, for example hydrogen. It is therefore possible according to the invention to dispense with a further process step and additional reducing agents.

The fact that the metal-doped support material prepared according to the invention comes into contact, if appropriate, with reducing compounds during subsequent use is, according to the invention, not within the scope of the preparation process according to the invention.

The reactor in which the at least one support material is reacted with the reaction gas can be operated continuously or batchwise. Suitable reactors are, for example, a tray reactor for batchwise operation or a moving bed or fluidized bed for continuous operation with continuous feed of support material and continuous removal of the metal-doped support material.

In addition to the preferred heat input into the circulated gas, indirect heat input via, for example, tube bundles present in the reactor is also possible. Furthermore, it is possible to use tubes which are heated by means of a double jacket and are filled with support material. Suitable heating media are the customary heat-transfer media known to the person skilled in the art, for example Marlotherm oil, salt melts or preferably superheated steam.

In a preferred embodiment, the exit gas which emerges from the reactor and, in a preferred embodiment, substantially comprises carbon monoxide (CO) can be recycled to the process according to the invention after compression or enrichment with the corresponding gaseous compound comprising the metal in the oxidation state 0, so that substantially no waste products or byproducts occur in this preferred embodiment.

The process according to the invention makes it possible to obtain metal-doped support materials which are distinguished by a particularly large BET surface area. Furthermore, a metal-doped support material is obtained in which the metal is present not only on the surface but also in the interior of the pores. The process according to the invention furthermore makes it possible to achieve particularly high loadings of the support material with at least one metal.

The present invention therefore also relates to a metal-doped support material which can be prepared by the process according to the invention.

In a preferred embodiment, the metal-doped support material comprises the at least one metal in elemental form in an amount of at least 1% by weight, preferably at least 5% by weight, particularly preferably at least 13% by weight, based in each case on the total metal-doped support material.

In a further preferred embodiment, the metal-doped support material which can be prepared by the process according to the invention has a BET surface area of at least 500 m²/g, particularly preferably at least 1000 m²/g. The metal-doped support material according to the invention is furthermore distinguished by a particularly uniform distribution of the at least one metal on the support material.

The present invention also relates to the use of the metal-doped support material according to the invention for the treatment of contaminated groundwater and wastewater, in particular for the degradation of pollutants by reduction, very particularly of halogenated hydrocarbons, nitro- and nitrosohydrocarbons and inorganic substances, such as, for example, mercury, cadmium, nickel, arsenate, arsenite, chromate, perchlorate, nitrate and mixtures thereof.

Processes for the decontamination of contaminated groundwaters or wastewaters by means of metal-doped support materials are known to the person skilled in the art and are described, for example, in TerraTech 6, 2007, 17-20.

### FIGURES

FIG. 1 shows a scanning electron micrograph (SEM) of a particle of an iron-doped active carbon obtained by the process according to the invention.

FIG. 2 shows a scanning electron micrograph (SEM) of the surface of an iron-doped active carbon obtained by the process according to the invention.

### EXAMPLES

### Example 1

The apparatus used consists of a double-tube evaporator for vaporizing the continuously metered, liquid iron pentacarbonyl Fe(CO)₅. The Fe(CO)₅ feed is 0.05 ml/min. The evaporator is operated at 120° C. In addition, a CO stream of about 0.4 l/h is fed to the evaporator. The Fe(CO)₅ vapor and the CO are fed to an 8 1 mm Teflon tube filled with active carbon pellets. The Teflon tube is heated via a double jacket with Marlotherm oil. During the deposition, the temperature is increased from 150° C. to 200° C. at a heating rate of 3 K/min. The deposition rate is monitored via a CO exit gas measurement. After the temperature ramp has reached 200° C., the Fe(CO)₅ feed is stopped. The active carbon used is a standard active carbon type 1 (AIR SLR-Ultra, from Obermeier).

### Result:

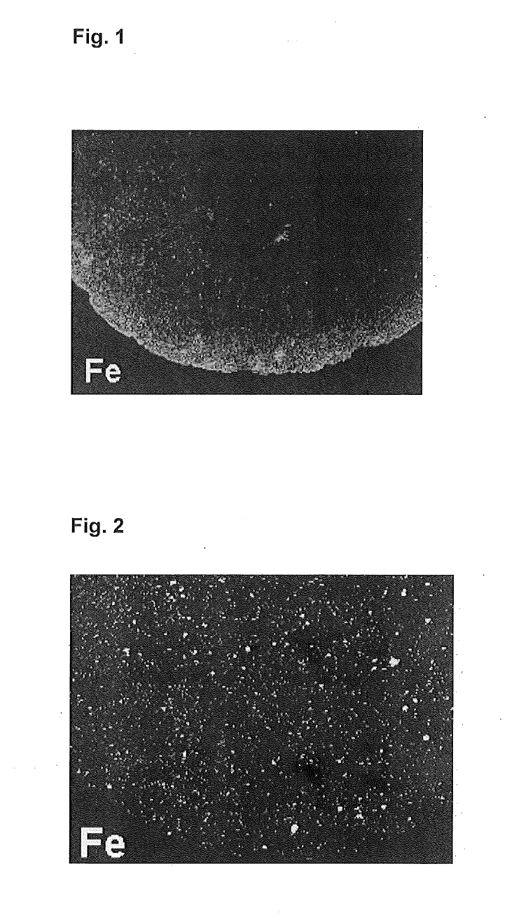

During the experiment, the amount of exit gas increases continuously to 3 l/h from 160° C. to 200° C. The samples removed are investigated for iron content and BET surface area before and after the experiment. The iron content of the untreated active carbon is 0.92 g/100 g, corresponding to 0.92% by weight, and the BET surface area is 1405 m²/g. The iron content of the treated active carbon removed is determined as 22.9 g/100 g, corresponding to 22.9% by weight, and the BET surface area is determined as 1186 m²/g. In addition, a plurality of strands are embedded, ground transversely to the strand axis and imaged in SEM (scanning electron microscopy) by means of back-scattered electrons (BE). In FIG. 1, regions of higher density appear lighter (higher concentration/higher atomic number of the elements/lower porosity).

### Example 2

The apparatus used consists of a double-tube evaporator for vaporizing the continuously metered, liquid iron pentacarbonyl Fe(CO)₅. The Fe(CO)₅ feed is 0.05 ml/min. The evaporator is operated at 120° C. In addition, a CO stream of about 0.7 l/h is fed to the evaporator. The Fe(CO)₅ vapor and the CO are fed into three glass containers of 100 ml each which are filled with active carbon pellets. A recycle gas stream of 800 l/h ensures uniform distribution of the Fe(CO)₅ vapor over the active carbon pellets. The glass containers are heated via a double jacket. During the loading of the active carbon pellets, the temperature remains constant at 150° C. After the metering of 21 ml of Fe(CO)₅, the feed of iron pentacarbonyl is stopped and the temperature of the glass vessels is increased to 180° C. The active carbon used is a standard active carbon type 1 (AIR SLR-Ultra, from Obermeier).

### Result:

During the loading of the active carbon pellets at 150° C., the amount of exit gas remains constant at 0.8 l/h. During the temperature increase to 180° C., the amount of exit gas increases continuously to >3 l/h. The samples removed are investigated for iron content before and after the experiment. The iron content of the untreated active carbon is 0.92 g/100 g, corresponding to 0.92% by weight. The iron content of the treated active carbon removed is determined as 13 g/100 g, corresponding to 13% by weight. In addition, a plurality of strands are embedded, ground transversely to the strand axis and imaged in SEM (scanning electron microscopy) by means of back-scattered electrons (BE). In FIG. 2, regions of higher density appear lighter (higher concentration/higher atomic number of the elements/lower porosity).

1. A process for the preparation of a metal-doped support material comprising at least one metal in elemental form on at least one support material which is based on carbon by gas-phase deposition of at least one compound comprising the at least one metal in the oxidation state 0 in combination with carbon monoxide on the at least one support material and thermal decomposition of the at least one compound comprising the at least one metal in the oxidation state 0 in order to obtain the at least one metal in elemental form, wherein, during and after the deposition and the decomposition, the support material is not brought into contact with reducing compounds during the preparation.

2. The process according to claim 1, wherein the metal is iron.

3. The process according to claim 1 or 2, wherein the support material is active carbon.

4. The process according to any of claims 1 to 3, wherein the compound comprising the at least one metal in the oxidation state 0 is iron pentacarbonyl Fe(CO)₅.

5. The process according to any of claims 1 to 4, wherein the deposition and the decomposition are carried out at a temperature of from 120 to 220° C.
